(19) United States
(12) Patent Application Publication
(10) Pub. No.: US 2009/0173003 A1
(43) Pub. Date: Jul. 9, 2009

(54) PLANT CARE DEVICE

(76) Inventor: VERNON L. MAYES, JR., Columbia, SC (US)

Correspondence Address: James Ray & Associates, 2640 Pitcairn Road, Monroeville, PA, 15146, US

(21) Appl. No.: 12/350,389

(22) Filed: Jan. 8, 2009

Related U.S. Application Data
(60) Provisional application No. 61/020,033, filed on Jan. 9, 2008.

(51) Int. Cl. A01G 25/00; A01G 29/00

(52) U.S. Cl. 47/79; 47/75; 47/39; 47/48.5

(57) ABSTRACT

A plant care device includes an outer pot manufactured from a first predetermined material and having a first predetermined size and a first predetermined shape. Such outer pot further includes a first drainage aperture having a first predetermined diameter disposed through a bottom portion thereof for allowing liquid to pass therethrough. An inner pot is manufactured from a second predetermined material and has a second predetermined size and a second predetermined shape for holding at least one of soil, at least one plant, liquid, fertilizer, at least one seed, and a combination thereof, and fits releasably within such outer pot. Such inner pot further includes a second drainage aperture having a second predetermined diameter disposed through a bottom portion thereof for allowing liquid to pass therethrough.

### CROSS REFERENCE TO RELATED APPLICATION

This patent application is related to and claims priority from U.S. Provisional Patent Application Ser. No. 61/020,033 filed Jan. 9, 2008.

### FIELD OF THE INVENTION

The present invention relates, in general, to plant devices and, more particularly, this invention relates to a plant care device which includes an inner pot which nests within an outer pot.

### BACKGROUND OF THE INVENTION

Prior to the conception and development of the present invention, plant pots as are generally well known in the prior art, have been used to contain soil and sometimes fertilizer for houseplants, hanging plants, and the like. Users often start to grow plants in such plant pots then transplant such plants to outdoor ground locations. Unfortunately, when plants are transplanted their roots are damaged and they may be planted in locations which fail to provide the appropriate amounts of sunshine, water, nutrients, and root space specifically needed for such plants to grow properly. Furthermore, once a plant has been planted outdoors, it is very difficult to move it to a new location without harming its root system, ultimately killing it or leaving it looking half dead, crooked, damaged and otherwise unhealthy.

Specifically of interest to the present invention are the following: Cochran, U.S. Pat. No. 6,525,693 discloses an in-ground planter assembly including a receptacle body having two or more recesses and which lies at ground level. Insert bodies pre-charged with soil and living plants are dropped into cavities in the receptacle body.

Billings, U.S. Pat. No. 6,223,466 discloses a planting system comprising an inner container and an outer container. The outer container is placed permanently into the ground. The inner container is then placed into the outer container. Plants are planted into the inner container either before or after the inner container is placed into the outer container.

Trabka, U.S. Pat. No. 6,901,700 discloses a combination pot which includes an outer pot, one or more inner pots and a support frame to support the inner pots in the outer pot. Soil is partially filled into the interior of the outer pot. The support frame is then positioned in the outer pot. The remainder of the filler soil is filled in around the support frame. Filler plants are planted in the filler soil. Inner pots having plant soil and decorative plants are inserted into the support frame.

Ganti, U.S. Publication No. 2007/0084107, discloses a nested two-piece Plant Potting Assembly which includes an Outer Pot that is substantially permanently installed below ground level such that its open side rim is substantially at ground level and rest of its body is below the ground level. An Inner Pot contains soil and plants.

None of the cited references provide the benefits attenuate with the present invention.

### SUMMARY OF THE INVENTION

The present invention provides a plant care device. Such plant care device includes an outer pot manufactured from a first predetermined material and having a first predetermined size and a first predetermined shape. Such outer pot further includes a first drainage aperture having a first predetermined diameter disposed through a bottom portion thereof for allowing liquid to pass therethrough. An inner pot is manufactured from a second predetermined material and has a second predetermined size and a second predetermined shape for holding at least one of soil, at least one plant, liquid, fertilizer, at least one seed, and a combination thereof, and fits releasably within such outer pot. Such inner pot further includes a second drainage aperture having a second predetermined diameter disposed through a bottom portion thereof for allowing liquid to pass therethrough.

### OBJECTS OF THE INVENTION

It is, therefore, one of the primary objects of the present invention to provide a plant care device which includes an inner pot having a maze type draining system in a lower portion thereof and wherein such plant care device includes an outer pot within which such inner pot may nest; such inner pot including at least one aperture for draining water from an interior of such inner pot into such outer pot and such inner pot being for receiving at least one of soil, water, seeds, fertilizer, plants, and a combination thereof. Such inner pot may further include a predetermined fertilizing means disposed at least one of therein and thereon.

Another object of the present invention is to provide a two pot plant care device which includes a inner pot and an outer pot, such inner pot fitting releasably within such outer pot and such inner pot being rotatable to at least two different positions within such outer pot. Such inner pot and such outer pot may further include a locking mechanism for locking such inner pot within each of such at least two positions.

It is a further object of the present invention to provide a device which includes an inner pot that may be easily removed from an interior portion of an outer pot such that such inner pot may be relocated to another location, possibly within another one of such outer pot, to provide a plant disposed within such inner pot with adequate nutrients, sunshine, water, and optimum temperature such that such plant may grow to its maximum potential.

Still another object of the present invention is to provide a two pot planter system which includes an inner pot and an outer pot, such inner pot releasably fitting within such outer pot, such outer pot being placed in ground such that a rim of such outer pot is substantially flush with such ground.

Yet another object of the present invention is to provide a two pot planting system which includes an inner pot having a maze type draining system in a lower portion of such inner pot and an outer pot for receiving such inner pot such that such inner pot nests within such outer pot; such inner pot further including at least one aperture disposed through a bottom thereof for at least one of draining water from an interior of such inner pot into such outer pot, and a combination thereof, such inner pot being for receiving at least one of soil, water, seeds, fertilizer, plants, and a combination and such inner pot further including a fertilizer rope disposed at a predetermined location thereon.

An additional object of the present invention is to provide a nestable planter system which will enable a user to relocate a plant easily from one location to another without transplanting such plant and which will also enable a user to rotate such plant 360 degrees within such nestable planter system without disturbing such plant's root system.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention in which a plant is growing within such inner pot.

FIG. 2 is a partial perspective view of the invention according to one embodiment of the invention in which such inner pot is shown fitting into such outer pot.

FIG. 3 is a partial perspective view of the invention according to one embodiment of the invention in which an interior of such inner pot is illustrated.

FIG. 4 is a partial perspective cut-away view of the inner pot of the invention according to one embodiment of the invention.

FIG. 5 is a partial perspective bottom view of the inner pot of the invention according to one embodiment of the invention.

FIG. 6 is a partial perspective view of the interior of the outer pot of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

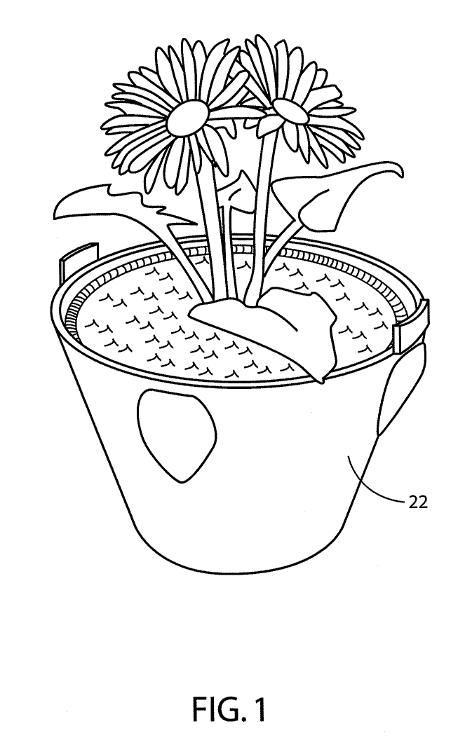

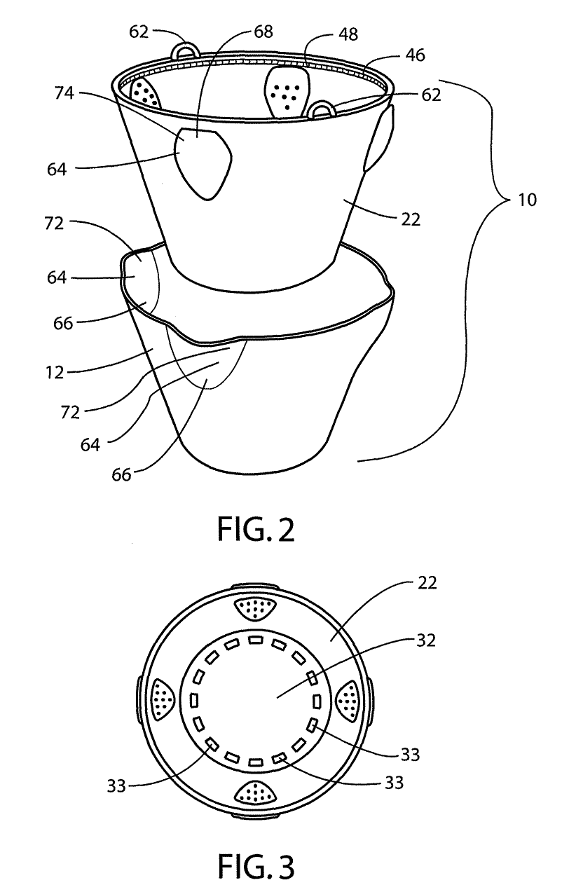

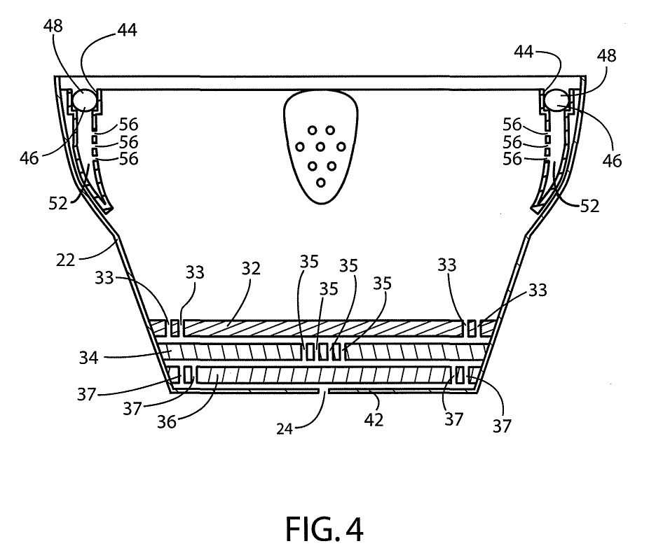

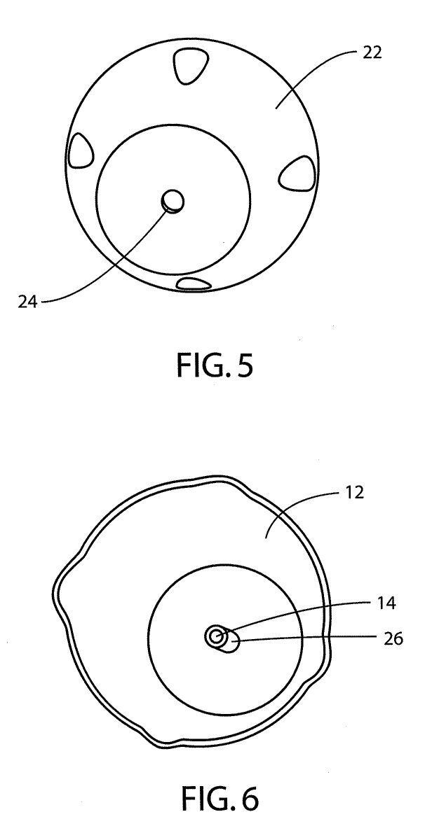

Reference is now made, more particularly, to FIGS. 1-6.

A plant care device, generally designated 10, is provided. Such plant care device 10 includes an outer pot 12 manufactured from a first predetermined material and having a first predetermined size and a first predetermined shape. Such outer pot 12 further includes a first drainage aperture 14 having a first predetermined diameter disposed through a bottom portion thereof for allowing liquid to pass therethrough.

An inner pot 22 is manufactured from a second predetermined material and has a second predetermined size and a second predetermined shape for holding at least one of soil, at least one plant, liquid, fertilizer, at least one seed, and a combination thereof, and fits releasably within such outer pot 12. Such inner pot 22 further includes a second drainage aperture 24 having a second predetermined diameter disposed through a bottom portion thereof for allowing liquid to pass therethrough.

It is presently preferred that the device 10 further includes a lip member 26 having a predetermined size and a predetermined shape disposed around a perimeter of at least one of such first drainage aperture 14 and such second drainage aperture 24 and wherein such first drainage aperture 14 is alignable with such second drainage aperture 24 such that such lip member 26 fits within an opposite one of such first drainage aperture 14 and such second drainage aperture 24. It is presently most preferred that such lip member 26 is disposed around such first drainage aperture 14.

It is presently preferred that such inner pot 22 further includes a first drainage plate 32 disposed within such inner pot 22 at a first predetermined location, such first drainage plate 32 including a first plurality of apertures 33 disposed there through closely adjacent at least one edge thereof for allowing liquid to pass therethrough.

It is presently preferred that such inner pot 22 further includes a second drainage plate 34 disposed within such inner pot 22 a predetermined distance below such first drainage plate 32, such second drainage plate 34 including a second plurality of apertures 35 disposed through a center portion thereof for allowing liquid to pass therethrough.

It is presently preferred that such inner pot 22 further includes a third drainage plate 36 disposed within such inner pot 22 a predetermined distance below such second drainage plate 34 and a predetermined distance above a bottom 42 of such inner pot 22, such third drainage plate 36 including a third plurality of apertures 37 disposed there through closely adjacent at least one edge thereof for allowing liquid to pass therethrough.

It is presently preferred that such inner pot 22 includes a channel 44 formed integrally therewith disposed along an upper interior portion thereof for housing a fertilizing means 46.

According to one embodiment such fertilizing means 46 is a fertilizer rope 48 impregnated with a first predetermined amount of a predetermined fertilizer.

According to a preferred embodiment such inner pot 22 further includes at least one reservoir member 52 formed adjacent a lower portion of such channel 44, such at least one reservoir member 52 further including a plurality of apertures 56 disposed through an inner wall thereof such that water (not shown) poured into such channel 44 will contact such fertilizer rope 48 and leech a second predetermined amount of such predetermined fertilizer therefrom and thereafter such water containing such second predetermined amount of such fertilizer will travel through such channel 44 and into such reservoir member 52 and pass through such plurality of apertures 56 into such inner pot 22.

According to another embodiment (not shown) such channel includes a plurality of apertures disposed through an inner wall thereof such that water poured into such channel will contact such fertilizer rope and leech a second predetermined amount of such predetermined fertilizer there from and thereafter such water containing such second predetermined amount of such fertilizer will exit through such plurality of apertures into such inner pot.

It is presently preferred that such inner pot 22 further includes at least one handle member 62 disposed on such inner pot 22 closely adjacent an outer upper edge thereof for grasping by a user to enable such user to lift such inner pot 22.

It is presently most preferred that a pair of handle members are disposed on such inner pot 22 opposite each other and closely adjacent an outer upper edge thereof for grasping by a user to enable such user to lift such inner pot.

It is presently preferred that such first predetermined shape is at least one of substantially round, substantially rectangular, substantially oval, and a combination thereof. It is presently most preferred that such first predetermined shape is substantially round.

It is presently preferred that such second predetermined shape is at least one of substantially round, substantially rectangular, substantially oval, and a combination thereof. It is presently most preferred that such second predetermined shape is substantially round.

It is presently preferred that such first predetermined shape and such second predetermined shape are substantially identical.

According to a preferred embodiment, such first predetermined shape and such second predetermined shape are substantially round and such device 10 further includes a locking means 64 having a first portion 66 disposed on such outer pot 12 and a second portion 68 disposed on such inner pot 22, such first portion 66 and such second portion 68 being releasably engageable with each other for preventing such inner pot 22 from rotating within such outer pot 12.

It is presently preferred that such first portion 66 is at least one cavity 72 extending outwardly from such outer pot 12 and wherein such second portion 68 is at least one protuberance 74 extending outwardly from a wall of such inner pot 22 such that such at least one protuberance 74 is alignable within such at least one cavity 72 and such at least one protuberance 74 fits snugly within such at least one cavity 72.

It is presently most preferred that such first portion includes a plurality of cavities and such second portion includes a plurality of protuberance, such plurality of protuberances being alignable with such plurality of cavities such that each one of such plurality of protuberances are alignable with and fit snugly within each one of such plurality of cavities.

A user of such device 10 is meant to grow a plant or plants within such inner pot; such inner pot being easily removable and rotatable within such outer pot. Such plant may be easily watered and fertilized therein, thereby improving plant growth and appearance. A user utilizing a plurality of such devices may switch the inner pots from one outer pot to another thereby enabling such user to create various aesthetically pleasing arrangements. The inner pots may be rotated to allow each side of a plant to receive enough sunshine to grow fully. Inner pots may be retrieved and taken to other locations for protecting plants within from frost, insects, animals, and the like and for pruning, trimming, and otherwise caring for such plants.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A plant care device comprising:
a. an outer pot manufactured from a first predetermined material and having a first predetermined size and a first predetermined shape, said outer pot further including a first drainage aperture having a first predetermined diameter disposed through a bottom portion thereof for allowing liquid to pass therethrough; and
b. an inner pot manufactured from a second predetermined material and having a second predetermined size and a second predetermined shape for holding at least one of soil, at least one plant, liquid, fertilizer, at least one seed, and a combination thereof, said inner pot fitting releasably within said outer pot said inner pot further including a second drainage aperture having a second predetermined diameter disposed through a bottom portion thereof for allowing liquid to pass therethrough.

2. A plant care device according to claim 1 wherein said inner pot further includes a first drainage plate disposed within said inner pot at a first predetermined location, said first drainage plate including a first plurality of apertures disposed therethrough closely adjacent at least one edge thereof for allowing liquid to pass therethrough.

3. A plant care device according to claim 2 wherein said inner pot further includes a second drainage plate disposed within said inner pot a predetermined distance below said first drainage plate, said second drainage plate including a second plurality of apertures disposed through a center portion thereof for allowing liquid to pass therethrough.

4. A plant care device according to claim 3 wherein said inner pot further includes a third drainage plate disposed within said inner pot a predetermined distance below said second drainage plate and a predetermined distance above a bottom of said inner pot, said third drainage plate including a third plurality of apertures disposed therethrough closely adjacent at least one edge thereof for allowing liquid to pass therethrough.

5. A plant care device according to claim 1 wherein said inner pot includes a channel formed integrally therewith disposed along an upper interior portion thereof for housing a fertilizing means.

6. A plant care device according to claim 5 wherein said fertilizing means is a fertilizer rope impregnated with a first predetermined amount of a predetermined fertilizer.

7. A plant care device according to claim 6 wherein said channel includes a plurality of apertures disposed through an inner wall thereof such that water poured into said channel will contact said fertilizer rope and leech a second predetermined amount of said predetermined fertilizer therefrom and thereafter said water containing said second predetermined amount of said fertilizer will exit through said plurality of apertures into said inner pot.

8. A plant care device according to claim 7 wherein said inner pot further includes at least one reservoir member formed adjacent a lower portion of said channel, said at least one reservoir member further including a plurality of apertures disposed through an inner wall thereof such that water poured into said channel will contact said fertilizer rope and leech a second predetermined amount of said predetermined fertilizer therefrom and thereafter said water containing said second predetermined amount of said fertilizer will travel through said channel and into said reservoir member and pass through said plurality of apertures into said inner pot.

9. A plant care device according to claim 1 wherein said first predetermined shape is at least one of substantially round, substantially rectangular, substantially oval, and a combination thereof.

10. A plant care device according to claim 9 wherein said first predetermined shape is substantially round.

11. A plant care device according to claim 1 wherein said second predetermined shape is at least one of substantially round, substantially rectangular, substantially oval, and a combination thereof.

12. A plant care device according to claim 11 wherein said second predetermined shape is substantially round.

13. A plant care device according to claim 1 wherein said first predetermined shape and said second predetermined shape are substantially identical.

14. A plant care device according to claim 1 wherein said first predetermined shape and said second predetermined shape are substantially round and said device further includes a locking means having a first portion disposed on said outer pot and a second portion disposed on said inner pot, said first portion and said second portion being releasably engageable with each other for preventing said inner pot from rotating within said outer pot.

15. A plant care device according to claim 14 wherein said first portion is at least one cavity extending outwardly from said outer pot and wherein said second portion is at least one protuberance extending outwardly from a wall of said inner pot such that said at least one protuberance is alignable within said at least one cavity and said at least one protuberance fits snugly within said at least one cavity.

16. A plant care device according to claim 15 wherein said first portion includes a plurality of cavities and wherein said second portion includes a plurality of protuberance, said plurality of protuberances being alignable with said plurality of cavities such that each one of said plurality of protuberances are alignable with and fit snugly within each one of said plurality of cavities.

17. A plant care device according to claim 1 wherein said inner pot further includes at least one handle member disposed on said inner pot closely adjacent an outer upper edge thereof for grasping by a user to enable such user to lift said inner pot.

18. A plant care device according to claim 1 wherein a pair of handle members is disposed on said inner pot opposite each other and closely adjacent an outer upper edge thereof for grasping by a user to enable such user to lift said inner pot.

19. A plant care device according to claim 1 wherein said device further includes a lip member having a predetermined size and a predetermined shape disposed around a perimeter of at least one of said first drainage aperture and said second drainage aperture and wherein said first drainage aperture is alignable with said second drainage aperture such that said lip member fits within an opposite one of said first drainage aperture and said second drainage aperture.

20. A plant care device according to claim 19 wherein said lip member is disposed around said first drainage aperture.
